(19) United States
(12) Patent Application Publication
(10) Pub. No.: US 2025/0239134 A1
(43) Pub. Date: Jul. 24, 2025

(54) DOCUMENT HANDLER, A GAMING MACHINE CONTROLLER UTILIZING THE DOCUMENT HANDLER AND A METHOD FOR MONITORING AND INDICATING DETERIORATION LEVEL IN THE DOCUMENT HANDLER

(71) Applicant: JAPAN CASH MACHINE CO., LTD., Osaka (JP)

(72) Inventors: Naomasa Adachi, Osaka (JP); Kohei Haraguchi, Osaka (JP); Hiroyuki Suzuki, Osaka (JP)

(21) Appl. No.: 19/094,713

(22) Filed: Mar. 28, 2025

Related U.S. Application Data
(63) Continuation of application No. PCT/JP2023/033329, filed on Sep. 13, 2023.

(30) Foreign Application Priority Data
Sep. 30, 2022 (JP) JP2022158418

(51) Int. Cl. G07F 17/32

(52) U.S. Cl. CPC G07F 17/3241

(57) ABSTRACT

A document handler for identifying, verifying and/or authorizing documents is disclosed herein. The document handler includes a passageway formed in a validator, and a drive unit detachably mounted in the validator. The drive unit works to convey documents along the passageway in the validator, and therefore, each part of the drive unit is gradually worn through operation cycles causing steady deterioration in its quality, performance and function. To monitor the deterioration, the drive unit has one or more drive sensors for detecting physical values related to the quality, performance and/or function of the drive unit and memory for storing the physical values detected by the drive sensors. Accordingly, reductions in physical values detected by the drive sensors can indicate the degree or level of deterioration in the drive unit. Once physical values reach a threshold value, notices can be transmitted to personnel to change out the drive unit before failure.

### CROSS-REFERENCE

This application is a continuation of, and claims priority to, PCT/JP2023/033329 filed Sep. 13, 2023 which claims priority to Japanese Patent Application No. 2022-158418 filed Sep. 30, 2022, both of which are incorporated herein for all purposes.

### FIELD OF THE INVENTION

The embodiments of the present invention relate to a document handler having a drive unit that is monitored by drive sensors to identify when the drive unit needs to be changed out. In one embodiment, a controller of gaming machines communicates with document handlers in each gaming machine and is configured to notify casino personnel when the deterioration level of the document handler requires the drive unit to be replaced.

### BACKGROUND

Document handlers are not new. However, document handlers, like many mechanical devices, show performance reductions over large cycles of operation. The performance reductions reduce overall profitability for the operator until repairs are completed. One of the most common failures of document handlers lies in degradation or deterioration of the drive unit that forms its moving components. If the drive unit fails, the subject machine (e.g., gaming machine) in which it is installed, is prevented from operating until a complete replacement of the drive unit.

The document handler shown in Applicant's Japanese Patent No. 5,484,866 (incorporated herein by reference) describes that a drive unit, validation unit and stacker unit may be individually assembled for their easy separation, removal, assembly, maintenance, inspection and exchange. In addition, the drive unit is made up of integrally assembled components, and therefore, it is advantageously and removably mounted in a casing and easily detached from the document handler for easy exchange, maintenance and inspection.

It would be advantageous to develop a document handler with means to identify deterioration of certain components prior to failure.

### SUMMARY

Since the drive unit continuously operates within the document handler, it is impossible to know the precise time when it will fail causing the machine in which it in installed to fail. In many instance, the drive unit suddenly fails, becomes inoperative or acts in an abnormal condition shutting down the related document handler and machine in which it is installed.

The embodiments of the present invention provide a document handler that notifies personnel of the deterioration level or exchange time for the drive unit.

The document handler according to the embodiments of the present invention comprises a validator for identifying, verifying and/or authorizing documents, a passageway formed in the validator, and a drive unit detachably mounted in the validator. The drive unit works to convey documents along the passageway in the validator, and therefore, each part of the drive unit is gradually worn through cycles of operation steadily deteriorating its quality, performance and/or function. To monitor the deterioration, the drive unit has one or a plurality of drive sensors for detecting physical values related to the quality, performance and/or function of the drive unit, and a property memory for storing the physical values detected by the drive sensors. Reductions in physical values detected by the drive sensors indicate the degree or level in deterioration of drive unit. Physical values may be continuously, regularly or, if necessary, searched, retrieved and displayed to objectively grasp the deterioration level related to the quality, performance and/or function of the drive unit.

Other variations, embodiments and features of the present invention will become evident from the following detailed description, drawings and claims.

### BRIEF DESCRIPTION OF THE DRAWINGS

Referring now to embodiments according to the present invention of the document handler, a gaming machine controller utilizing the document handler and a method for indicating deterioration level in the document handler, the drawings illustrate the followings:

FIG. 1 illustrates a sectional view of a document handler according to the embodiments of the present invention;

FIG. 2 illustrates an exploded view of the document handler showing a drive unit removed from a validator device of the document handler according to the embodiments of the present invention;

FIG. 3 illustrates a bottom view of the drive unit attached to the document handler according to the embodiments of the present invention;

FIG. 4 illustrates a perspective view showing a clock encoder for the drive unit according to the embodiments of the present invention;

FIG. 5 illustrates a sectional view of the drive unit attached to the validator device according to the embodiments of the present invention;

FIG. 6 illustrates a block diagram showing an electric structure of the drive unit according to the embodiments of the present invention; and

FIG. 7 illustrates a graph of a failure rate curve characteristic of the drive unit according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

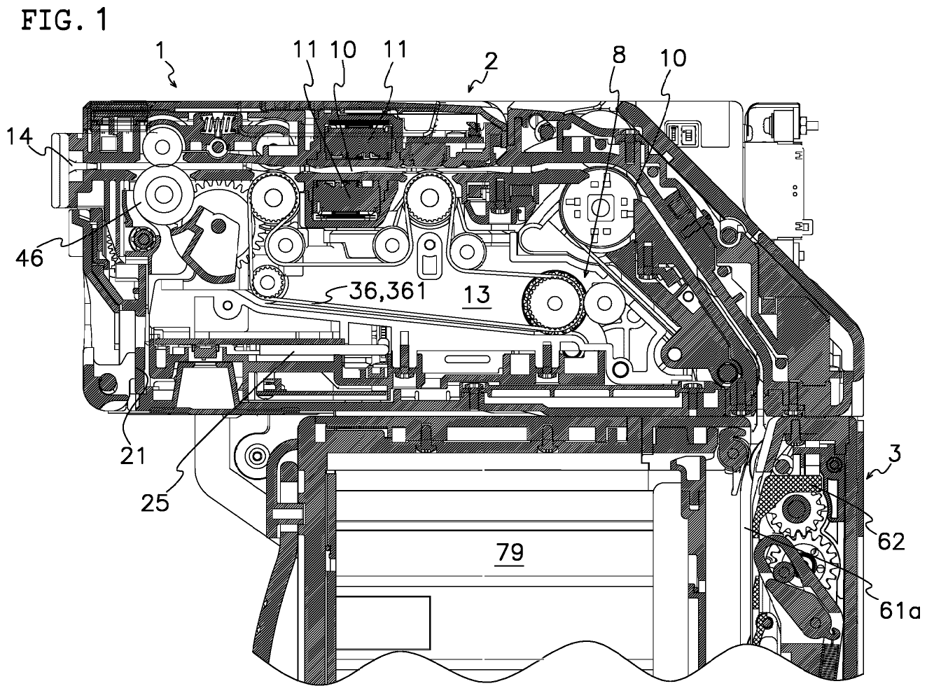

Referring now to FIGS. 1 to 7, embodiments of the present invention are explained in reference to a document handler, a controller of gaming machines utilizing said document handlers and a method for indicating a deterioration level in the document handler. The terms herein “a document” and “a paper” should be understood broadly to mean at least bills, currencies, paper currencies, plastic currencies, coupons, token monies, securities and scrips.

### Basic Construction of the Document Handler

The document handler (1) according to the embodiments of the invention has an improvement in the mechanical and electrical construction of the drive unit (13) over prior art drive units. While the drive unit (13) detailed herein is different in mechanical and electrical construction over the prior art, the validator (2), that may include a passageway (10) and stacker (3), may be of the same construction as previously taught. Specifically, drive unit (13) comprises one or a plurality of drive sensors (24) for detecting physical values related to the quality, performance and/or function of each working component of the drive unit (13), and a property memory (25) for storing the physical values detected by the drive sensors (24) to objectively determine and show the aged deterioration or degraded state related to the quality, performance and/or function of the drive unit (13).

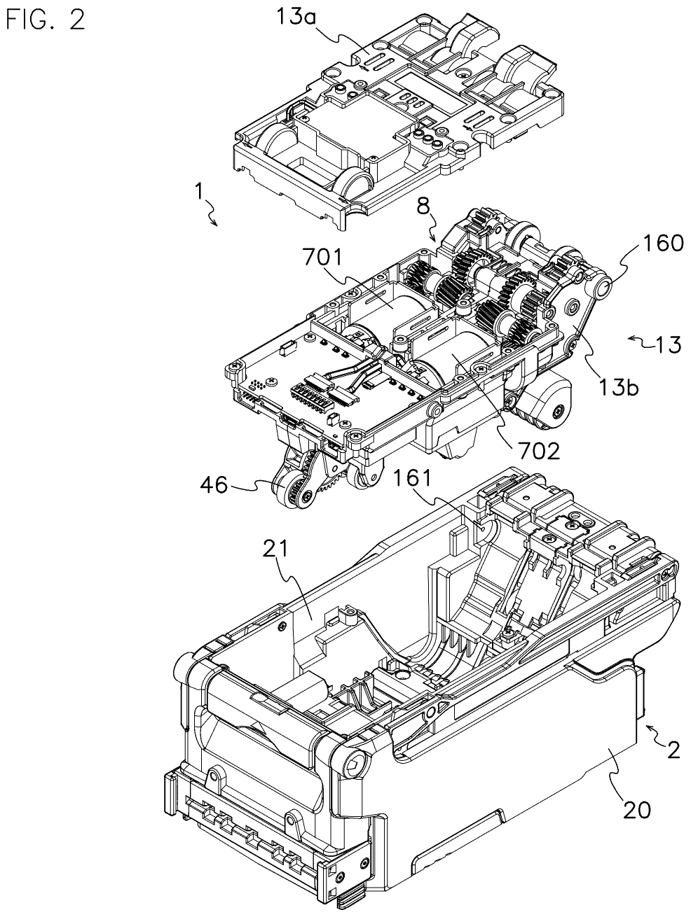

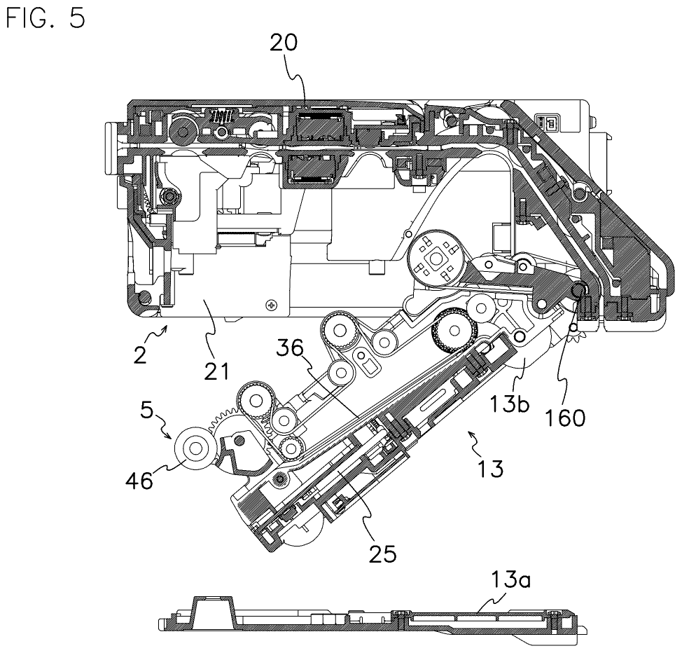

Document handler (1) shown in FIG. 1, comprises a validator (2) for identifying, verifying and/or authorizing documents to determine whether documents are genuine or fake, a passageway (10) formed within the validator (2), and a drive unit (13) for transporting documents within the validator (2). The drive unit (13) comprises a conveyor (5), shown in FIG. 5, for transporting a document inserted into the validator (2) along the passageway (10) and a pusher (6) for stowing the document transported through the passageway (10) by the conveyor (5) into a stacker (3). As shown in FIG. 2, the drive unit (13) has a bottom cover (13a) to conceal and protect the bottom surface of the drive unit (13).

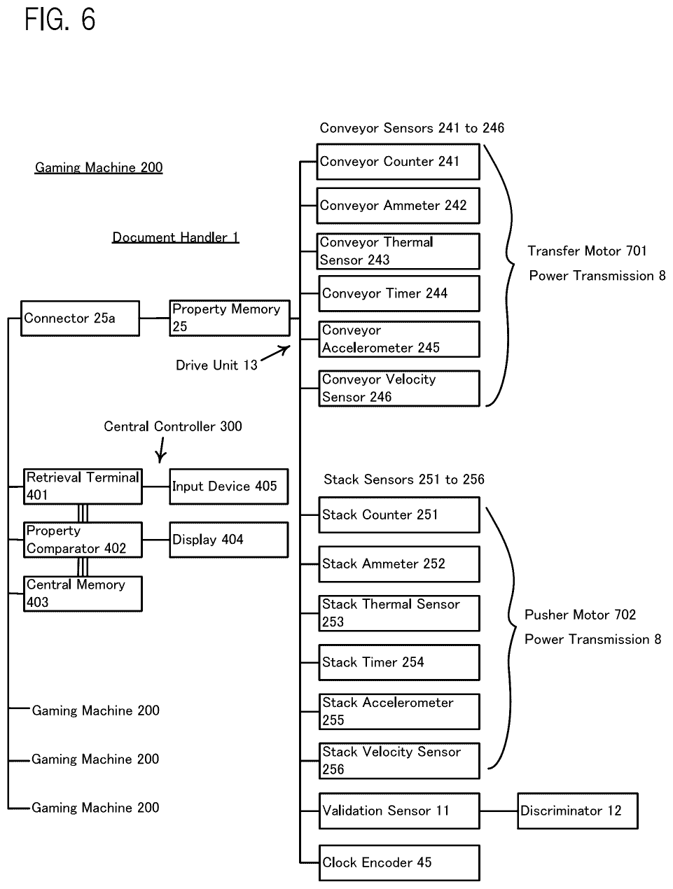

The validator (2) further comprises a validation sensor (11) for detecting optical features of the document moving through the passageway (10) by the drive unit (13) to produce detection signals, and a discriminator (12), shown in FIG. 6, for receiving detection signals from the validation sensor (11) to decide authenticity of the document. A sort sensor (11) is, for example, a close-contact image sensor (CIS) that may hold optical image data of the document moved along the passageway (10) to generate detection signals that form optical images of the document. Discriminator (12) compares optical image data of a document from validation sensor (11) with stored image data of an authentic or genuine document, and when it decides the two agree, the document is further transferred through the passageway (10) by drive belts (36) of the conveyor (5) to the stacker (3). Then, the document is conveyed to a standby room (61a) of a container (79) where a pusher actuator (62) forces the document from the standby room (61) into the container (79). When container (79) is filled with documents, a facility manager may detach the stacker (3) of filled container (79) from the document handler (1) to retrieve the documents within the container (79).

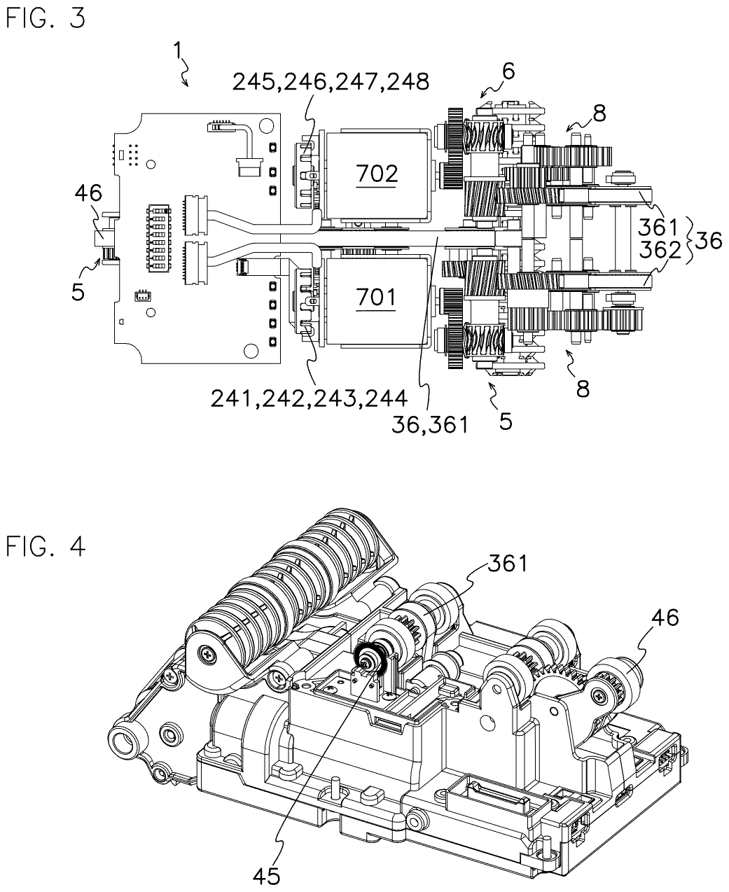

FIG. 3 illustrates the mechanical construction of the drive unit (13) comprising a transfer motor (701), a conveyor (5) for transporting a bill (or other document) inserted into the validator (2) along the passageway (10), and a pusher motor (702) and a pusher (6) for conveying and cramming the bill into the container (79) of the stacker (3). Reference can be made to Applicant's Japanese Patent No. 5,484,866 to more fully understand the actual construction and function of conveyor (5) and pusher (6) that utilize the transfer motor (701) and pusher motor (702), respectively, to transport and stow the bill into the stacker (3) by means of a power transmission (8). The embodiments of the present invention are more advantageous in that a plurality of conveyor sensors (241 through 246) detect a variety of physical values related to the quality, performance and/or functions of many or every working part in the conveyor (5) that includes the transfer motor (701) and power transmission (8). By doing so, the conveyor sensors (241 through 246) generate transfer logs that are digitized, graded and/or rated from detected physical values.

The conveyor (5) comprises a reversible transfer motor (701), a pinion (not shown) mounted on a drive shaft of the transfer motor (701), a power transmission (8) drivingly connected to the drive shaft of the transfer motor (701), and a drive belt (36) driven by the pinion of the transfer motor (701) and the power transmission (8). The drive belt (36) comprises a fore belt (361) allowing rotation of an inlet roller (46) arranged at the front center of the passageway (10) to carry the bill back, and a pair of rear belts (362) for carrying the bill farther back. The fore and rear belts (361, 362) are driven by the transfer motor (701) through the power transmission (8). In one embodiment, the inlet roller (46) is rotated through a gear meshed with a further gear rotated by the fore belt (361).

The document handler (1) has a stacker (3) for stowing bills transported along the passageway (10), and the drive unit (13) comprises a pusher (6) for stowing the bill into the container (79) of the stacker (3). In one embodiment, the document handler (1) utilizes a plurality of stack sensors (251 through 256) to detect a variety of physical values related to the quality, performance and/or functions of many or every working component in the pusher (6) that includes pusher motor (702) and power transmission (8). By doing so, the stack sensors (251 through 256) generate transfer logs that are digitized, graded and/or rated from detected physical values.

FIG. 6 illustrates an electrical construction of the drive unit (13) according to the embodiments of the present invention. The conveyor (5) comprises a clock encoder (45) rotated by the fore belt (361) that rotates the inlet roller (46) to measure turnover time of the transfer motor (701) and produces signals of its number and revolution rate. In other words, the clock encoder (45) may measure rotation time, rotation rate and revolution speed of transfer motor (701). The inlet roller (46) is rotated by or through a gear (not shown) together with the fore belt (361) to convey bills put into the inlet (14) along the passageway (10).

In this way, the fore belt (361) drives both the clock encoder (45) and the inlet roller (46). The property memory (25) is connected to clock encoder (45) to store actuating time of the drive unit (13) clocked by the clock encoder (45) and drive logs from the drive sensors (24) that may detect a variety of physical values related to the quality, performance and/or functions of many or every working part in the conveyor (5) and the pusher (6). The transfer motor (701), pusher motor (702) and power transmission (8) are contained by the conveyor (5) and the pusher (6) to generate drive logs based on physical values detected by drive sensors (24) which are converted by digitizing, grading, scoring and/or rating so that the property memory (25) stores drive logs.

### Electrical Structure of the Drive Unit

All the drive sensors (24), validation sensor (11) and clock encoder (45) may measure physical values of the transfer motor (701) and the pusher motor (702) and are in communication with the property memory (25) to select physical values detected by the drive sensors (24) and save the physical values in necessary memory areas together with time signals clocked by clock encoder (45). Also, the validation sensor (11) produces, forms and forwards optical image signals of the bills to the discriminator (12) to decide authentication, namely whether such bills are genuine or fake. When the discriminator (12) determines, based on optical image signals, the bills to be genuine, the bills are sent to the container (79) by the conveyor (5) and the pusher (6).

When optical image signals of the bills are not deemed to be genuine, the discriminator (12) adversely drives the conveyor (5) to return the bills through the passageway (10) towards the inlet (14) and again forwardly drives the conveyor (5) along the validation sensor (11) for repetitive optical validation (revalidation). In one embodiment, the property memory (25) may count and store the number of revalidation attempts. The document handler (1) or the drive unit (13) is connected to a retrieval terminal (401) of a central controller (300) and the property memory (25) through a connector (25a) such as a USB interface to retrieve physical values from and retain them in the property memory (25) and display them via the retrieval terminal (401). The central controller (300) may comprise computers such as servers and related peripheral equipment. FIG. 6 illustrates the transfer motor (701) and the pusher motor (702) of the drive unit (13) and the drive sensors (24) for detecting physical values in the transfer motor (701) and the pusher motor (702).

Each of the drive sensors (24) may continuously or periodically detect analog or digital physical values of working components in the drive unit (13) and forward them to the property memory (25) to store physical values in given storage areas. When each of the drive sensors (24) obtains physical values in the drive unit (13), they may convert analog physical values to digital ones (digitizing), grade, score and/or rate them into drive logs that are forwarded to the property memory (25) to store in given storage areas. The property memory (25) also may store transfer logs and stack logs for drive logs relating to operating time of the transfer motor (701) and the pusher motor (702) clocked by clock encoder (45). While physical values detected by the drive sensors (24) are digitized, graded, scored and/or rated, they may be divided into several grades or levels that include blank original figure areas, rates for reference values or predetermined values to separately save them in the property memory (25).

As mentioned above, each of the drive sensors (24) may convert analog physical values in the drive unit (13) into digital amounts or values, grade, score and/or rate them into drive logs that are forwarded to the property memory (25). Alternatively, the drive sensors (24) may forward analog physical values to the property memory (25) that may convert analog physical values to digital ones, grade, score and/or rate them into drive logs for storage.

The property memory (25) may retain transfer or stack logs for drive logs in relation to operating time of the transfer motor (701) and the pusher motor (702) clocked by the clock encoder (45). At the same time the property memory (25) stores drive logs detected by the drive sensors (24), it also saves authentication information, such as serial numbers, for identifying each of the drive units (13) or the document handlers (1). Automatically, at the time the property memory (25) receives a request signal from an input device (405) of the central controller (300) or after a certain period of time from receiving the request signal, the property memory (25) forwards stored drive logs and authentication information to retrieval terminal (401) through the connector (25a) to keep drive logs and authentication information in retrieval terminal (401).

When the central controller (300) receives drive logs and authentication information through the connector (25a), it may score physical values detected from drive units (13). Specifically, the central controller (300) grades each of the physical values and forwards them to a central memory (403) for storage whereby graded physical values include elapsed time since previous changed day or maintenance inspection day, number of operation cycles, total operation time, maximum temperature during operation, number of operation stops, and transportation accuracy (transportation stigmas) of bills. When a total score of the physical values of working parts of the conveyor (5) or the pusher (6) are not within an acceptable tolerance, a property comparator (402) of the central controller (300) may recognize the possibility of a future failure in at least one of the conveyor (5) and/or the pusher (6), generate warning signals and notify a manager of necessity of exchange or maintenance inspection of the drive unit (13).

For example, assuming a new drive unit (13) has a score of 100 points for total physical values and a broken drive unit (13) has a low score of 70 points, when the total physical values of a drive unit (13) drop from 100 points to 80 points due to degradation, the central controller (300) notifies a manager of the necessity to exchange or maintenance inspection of the drive unit (13). Thus, the function-degrading drive unit (13) may be exchanged with a new one responsive to the information from the central controller (300) to avoid actual failure or a complete breakdown of drive unit (13). For example, when the transfer motor (701) or the pusher motor (702) has been working in an atmosphere with temperature above 90° C. or average temperatures above 80° C., total physical values of the drive unit (13) may be reduced. According to added elapsed time, number of operation cycles, total operation time and number of operation stops, total physical values of the drive unit (13) may also be reduced. Moreover, when the transfer motor (701) or the pusher motor (702) is driven more than, for example, 500,000 times since brand new or a previous exchange of the drive unit (13), the total physical values of the drive unit (13) are reduced.

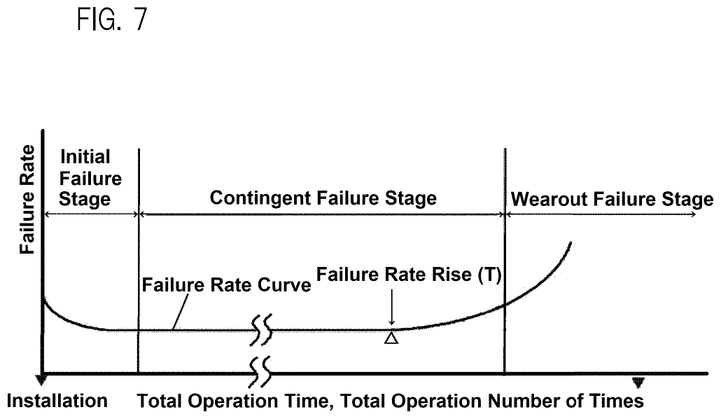

The property comparators (402) of another type may be used to calculate or predict exchange time or exchange priority order of the drive unit (13) in accordance with a statistics-converting algorithm. As illustrated in FIG. 7, when the central controller (300) receives drive logs and authentication information from the property memory (25) through the connector (25a), the property comparator (402) may compare drive logs received by the central controller (300) with failure rate curve characteristics of the drive unit (13) retained in the central memory (403). In this case, the property comparator (402) may decide how or what level of deterioration the received drive logs have on failure rate curve characteristics. In other words, the property comparator (402) may locate drive logs that fall below the deteriorated position on the failure rate curve characteristics, and then, it may compute a latest exchange time or residual time or days until the deteriorated position on the failure rate curve characteristics will be reached. For example, when reaching 80% abrasion loss or slip in quality just before final failure in total operation time to indicate a latest exchange time via display (404).

When the central controller (300) receives drive logs and authentication information from the property memory (25) through the connector (25a), the property comparator (402) may substitute drive logs for failure-rate approximation or function of the drive unit (13) retained in the central memory (403). In this instance, the property comparator (402) may compute residual time or days from the current failure rate position on the failure-rate approximation to the latest exchange time or term of the drive unit (13), for example when reaching 80% abrasion loss or slip in quality just before final failure in total operation time to show latest exchange time or term on display (404).

FIG. 7 shows the failure rate curve characteristics with the horizontal temporal axis exhibiting operation hours of the drive unit (13) and the vertical axis indicating the variation of the physical values detected from the drive sensors (24). The property memory (25) has an oscillator or oscillating circuit that produces clock signals to compute duration, velocity and acceleration of the physical values based on clock signals from an oscillator in the property memory (25). The property memory (25) also stores authentication information to identify the drive unit (13) or the document handler (1) for supporting the property memory (25), and past maintenance inspection history inclusive of repair and checkout of the drive unit (13).

The drive sensors (24) of FIG. 6 in the conveyor (5) according to the embodiments of the invention, comprise a conveyor counter (241) for counting each operation time of a conveyor motor (701) and forwarding counted time signals to the property memory (25); an overcurrent detection resistor or conveyor ammeter (242) for measuring overcurrent values and the number of times overcurrent passed through the conveyor motor (701) and forwarding to the property memory (25) counted high current values, high current time and high current times; and a conveyor thermal sensor (243) for measuring environmental temperature, high temperature duration and its frequency around the conveyor motor (701) each time it operates and forwarding digital signals of the counted data to the property memory (25).

Each of the drive sensors (24) comprises a conveyor timer (244) for counting total operation time and cycles of the conveyor motor (701) and forwarding digital signals of the counted data for drive logs to the property memory (25); a conveyor accelerometer (245) of, for example, crystal type for measuring low acceleration and its frequency each time the conveyor motor (701) operates and forwarding digital signals of the counted data for drive logs to the property memory (25); and a conveyor velocity sensor (246) for measuring rotational velocity of the conveyor motor (701) operates and forwarding digital signals of counted data for drive logs to the property memory (25).

Similar to the conveyor motor (701), the pusher motor (702) includes drive sensors (24) that may comprise a stack counter (251) for counting operation time of the pusher motor (702) each time the pusher motor (702) operates and forwarding counted digital data for drive logs to the property memory (25); an overcurrent detection resistor or stack ammeter (252) for measuring overcurrent values and its frequency passing through pusher motor (702) each time it operates and forwarding counted digital data to the property memory (25); and a stack thermal sensor (253) for measuring environmental temperature, high temperature duration and its frequency around the pusher motor (702) each time it operates and forwarding digital signals of counted data to the property memory (25).

Each of the drive sensors (24) comprises a stack timer (254) for counting total operation time and its frequency of the pusher motor (702) each time it operates and forwarding digital signals of the counted data for drive logs to the property memory (25); a stack accelerometer (255) of crystal type for measuring low acceleration and its frequency of the pusher motor (702) each time it operates and forwarding digital signals of the counted data for drive logs to the property memory (25); and a stack velocity sensor (256) for measuring rotational velocity of the pusher motor (702) each time it operates and forwarding digital signals of counted data for drive logs to the property memory (25).

In one embodiment, the conveyor and stack thermal sensors (243, 253) comprise thermoscopes that indicate digital signals of current change or resistance variation by motor winding temperature changes of the conveyor motor (701) and the pusher motor (702). In short, the clock encoder (45) generates clock signals that may count operation time of the conveyor motor (701) and the pusher motor (702). The property memory (25) may store operation time of the drive unit (13) measured by the clock encoder (45) and drive logs from the drive sensors (24).

Accordingly, the conveyor and stack thermal sensors (243, 253) may detect temperatures in the conveyor motor (701) and the pusher motor (702) each time the conveyor (5) and the pusher (6) operate to produce digital signals converted from temperature detection signals and forward them to the property memory (25) for storage. Temperature values converted into digital signals are displayed for digitized, graded, scored and/or rated drive logs to store them in the property memory (25). Transport and stack velocity sensors (245, 255) may detect the rotation rate of the transport motor (701) and the pusher motor (702) to produce converted velocity detection digital signals and forward them to the property memory (25) for storage. Digitalized velocity detection signals are displayed for digitized, graded, scored and/or rated drive logs to store them in the property memory (25). It should be noted that reduced amount of the physical values or digitized velocity detection signals from the transport and stack velocity sensors (245, 256) indicate aging or deterioration of the drive unit (13).

One of the major failure causes of the drive unit (13) related to the aging or depletion of working areas that make up the transport motor (701) and/or the pusher motor (702) and the power transmission (8). The following paragraphs detail each failure cause relative to replacement of the drive unit (13) before its failure or complete breakdown.

### Abrasion

Abrasion breakdown is caused by wear according to the total operation time of the transport motor (701) and the pusher motor (702) since abrasion loss of these motors (701, 702) is proportional to their total operation time. For this reason, it is advisable to count each operation time of the transfer motor (701) and the pusher motor (702) by the transfer and stack counters (241, 251) that send counted time signals to the property memory (25) for computation of total operation time of the transfer motor (701) and/or pusher motor (702) for storage.

FIG. 7 illustrates the failure rate of the drive unit (13) along the vertical axis and total operation time or cycles along the horizontal axis to show a bath-tub type or failure rate curve characteristics. The shown curve characteristics is made up of three (3) aging terms or stages, namely initial, contingent and final failure stages in time sequence. Initial and contingent failure stages of the three stages are out of consideration because the drive unit (13) very rarely has trouble during the initial and contingent failure stages as the drive unit (13) expected to operate in a stable manner without suffering a substantial malfunction. However, the failure rate rise (T) rapidly increases failure rates toward the abrasion failure stage.

For example, experimental data or repair activities teach that slide-type transfer motor (701) or pusher motor (702) reach the failure rate rise (T) after approximately five hundred (500) hours of operation. In other words, the failure rate growth (T) means the approximate arrival at 90% of the total hours of operation where the drive unit (13) moves from contingent to abrasion failure stage. For this reason, it is reasonable to give a manager warning signals from the property memory (25) to notify management to exchange of the drive unit (13) in advance when the transfer motor (701) and/or the pusher motor (702) has reached 400 hours of operation or 80% abrasion loss (deterioration degree) before the abrasion failure stage. In any event, the manager may set an exchange time of the drive unit (13) between 70% to 90% of the total hours of operation before the failure rate rise (T) shown in the failure rate curve characteristic or approximation. The property memory (25) is connected to any warning device that may produce acoustic or visual alarms activated by trigger signals from the property memory (25). Assuming that neither abrasion, fatigue nor thermal damage occurs in any part of the document handler (1) other than the drive unit (13), failure rate curve characteristics of the document handler (1) are returned to the original normal situation after exchange of the drive unit (13).

### Fatigue Accumulation

Even though the transfer motor (701) and/or the pusher motor (702) are driven under the low load condition, fatigue breakdown may occur due to reduced allowable stress ranges through their repeated operation. The transfer motor (701) and the pusher motor (702) generate fatigue breakdown based on their accumulated multi-operations as fatigue accumulates in the transfer motor (701) and/or the pusher motor (702) until fatigue breakdown acts according to the rate curve characteristics shown in FIG. 7. Accumulated fatigue is considered proportional to the number of cumulative repetitive cycles of the transfer motor (701) and/or the pusher motor (702). The transfer counter (241) and/or stack counter (251) or other counters may count operational frequency of the transfer motor (701) and/or the pusher motor (702) and forward counted operational frequency signals to the property memory (25) that computes cumulative operational frequency of the transfer motor (701) and/or the pusher motor (702) and stores them. Assuming fatigue breakdown occurs when cumulative operation frequency of the transfer motor (701) and/or the pusher motor (702) empirically reaches 500,000 cycles of operation, the frequency of the transfer motor (701) and/or pusher motor (702) reaches 80% abrasion at 400,000 cycles of operation whereby the property memory (25) produces warning signals to request a manager exchange the drive unit (13).

### Overcurrent Damage

Deformation of a component for any reason can inhibit smooth operation of the drive unit (13), and moreover, the deformation of the component may result in a rising load causing overcurrent flow through the transfer motor (701) and/or the pusher motor (702). Frequent overcurrent may cause thermal destruction or breakdown of the transfer motor (701) and/or the pusher motor (702). Accordingly, the overcurrent detection resister and transfer ammeter (242) and/or the stack ammeter (252) are used to measure high current values, duration thereof and the frequency of current flow through the transfer motor (701) and/or the pusher motor (702). The data are then forwarded to the property memory (25) that computes high current values, duration thereof and frequency through the transfer motor (701) and/or the pusher motor (702) and stores them. Assuming thermal breakdown by high current occurs when (i) current flow exceeds 10 amperes; (ii) for more than three seconds and (iii) more than five times, once these thresholds are reached, the property memory (25) may produce warning signals to request a manager exchange the drive unit (13).

### Thermal Damage at Elevated Temperature

Plastic molded electronic devices can be mounted in the transfer motor (701) and the pusher motor (702). The plastic molded electronic devices might fail or break when exposed to high temperatures above 120° C. For this reason, the transfer sensor (243) and the stack sensor (253) are used to measure environmental temperature, duration thereof and frequency proximate to the transfer motor (701) and the pusher motor (702). The collected data are then forwarded to the property memory (25) that computes measured environmental temperature, duration thereof and frequency and stores them. For example, when atmospheric temperature exceeds 120° C. for 30 seconds on 3 separate occasions, the property memory (25) may consider such a situation likely to result in the thermal breakdown of plastic molded electronic devices and thus produce warning signals urging a manager to exchange the drive unit (13).

### Reduction in Operating Rate

The drive unit (13) may reduce its operation speed for any specific cause or complex degradation. For instance, when a bill with any adhesive material is transported along the passageway (10), the material may adhere to the conveyor (5) and/or the pusher (6) greatly reducing drive performance of the drive unit (13). The same result occurs when foreign objects enter the conveyor (5) or the pusher (6). The transfer timer (244) and the stack timer (254) are used to measure total running time and frequency, and may count a low running rate and its frequency that are forwarded to the property memory (25) for storage. When receiving a given low running rate and/or frequency, the property memory (25) produces warning signals urging a manager to exchange the drive unit (13).

For example, when a customer spills a drink or other liquid near the inlet (14) of the passageway (10), such liquid may adhere to any of the conveyor (5), the pusher (6) and/or the power transmission (8) causing a delay or change in the drive rate of the transfer motor (701) and/or the pusher motor (702). The central controller (300) constantly monitors change in the drive rate of the transfer motor (701) and the pusher motor (701). If the transfer motor (701) and/or the pusher motor (702) do not drive at a predetermined rate, the central controller (300) considers that the delay may be caused by adhesive attachment to the mechanism and generates warning signals to notify a manager to replace the drive unit (13). Similarly, when foreign substances, such as dust or sand, enter the passageway (10) through the inlet (14), attachment of foreign substances to the power transmission (8) causes a delay in the running rate of the transfer motor (701) and/or the pusher motor (702). In this instance, the conveyor sensors (241 to 246) digitize the delay in transportation by foreign objects, monitor increased transporting load, and produce warning signals to notify a manager to swap the drive unit (13).

### Reduction of Working Acceleration

The drive unit (13) may encounter acceleration reductions due to the deformation of components or parts or other causes resulting in decreased rotational forces necessary for the transportation or storage of bills. The transport and stack velocity sensors (245, 255) of crystal type are used to detect low acceleration and its frequency of the transfer motor (701) and/or the pusher motor (702) to send detected signals to the property memory (25) that computes detected low acceleration and its frequency and stores them. When measuring a low acceleration below a threshold value, the property memory (25) generates warning signals to urge a manager to replace the drive unit (13).

The transport and stack acceleration sensors (245, 255) may detect acceleration of the transfer motor (701) and/or the pusher motor (702), convert detected acceleration into digital signals each time the conveyor (5) and the pusher (6) operate, and forward them for drive logs to the property memory (25) that stores digitized, graded, scored and/or rated drive logs. Physical values from the transport and stack acceleration sensors (245, 255) may indicate aging or deterioration in the drive unit (13).

### Cogging of Drive Unit

If there has been cogging in the conveyor (5), a document is transported with unusual velocity causing optical validation sensors (11) to form inappropriate bill images such as missed, deformed, shrunk, stretched or slipped optical images of bills so that the discriminator (12) may not correctly authenticate a bill. For example, if the discriminator (12) cannot correctly read an identification indicia such as barcoded print on a bill, the discriminator (12) produces incorrect signals to forwardly operate the drive unit (13) for repetitive validation of the bill. In one embodiment, the property memory (25) saves the number of times a bill is validated by the discriminator (12) to create drive logs.

### Slipping of the Drive Unit

In one embodiment, the property comparator (402) compares bill length information sent to the retrieval terminal (401) by the property memory (25) against standard length information stored in the central memory (403). If the length of an image read by validation sensor (11) is not within a predetermined range, the property comparator (402) may decide that there is an occurrence of slippage in the drive unit (13). In this instance, the property memory (25) may count the number of times slippage occurs during belt-drive and the retrieval terminal (401) displays the number of slippage times during belt-drive. When the number of slippage times is over predetermined frequency saved in the central memory (403), the property comparator (402) may determine a slipping failure in the conveyor (5). For example, the property memory (25) may store delay time in the operation from the pusher (6), current flow level in operation from stack ammeter (252), and stack logs from stack acceleration sensor (255) and stack velocity sensor (256) to notify a manager to exchange the drive unit (13).

In one embodiment, the drive unit (13) measures the pulse width of drive signals to the transfer motor (701) and/or the pusher motor (702) to operate the pusher (6) or the pusher actuator (62) and when the drive unit (13) detects a predetermined total pulse length, drive unit (13) may decide the container (79) of the stacker (3) is full of bills. The property memory (25) may hold authentication information of the drive unit (13) or the document handler (1) that provides the container (79) filled with bills to exchange deteriorated-like stacker (3).

Each part forming the drive unit (13) is destined to decline in quality, performance and/or function over time resulting in operational deterioration of the drive unit (13). As mentioned above, failure may occur for various reasons related to the transfer motor (701), the pusher motor (702) and the power transmission (8), such as an increase in the total operation time or accumulative iterative operation frequency, change in circumferential temperature, abnormal rotation output, expansion of abrasion loss, hypofunction or deterioration of strength by repeated operation, fatigue enlargement by repeated low load or slippage of the belt-drive.

If actual mechanical and electrical components and their functions for the drive unit (13) are degraded, failure rate curve characteristics of the drive unit (13) are observed, supposed and/or shown by approximation regarding failure causes, such as abrasion, fatigue, overcurrent damage, thermal damage, reduction in operative rate or acceleration and stored as failure rate characteristic data or failure rate approximation data in the central storage (403). FIG. 7 shows failure rate characteristic data or their approximation by bath-tab type-curve, quadratic curve, straight line or other failure characteristic curves. The property memory (25) holds the data of the drive unit (13) or gaming machine (200) relative to actual operation values of the drive unit (13) such as total operation time and cycles, environmental temperature, duration and frequency of high temperature, low operation velocity and its frequency, and low acceleration and its frequency. The retrieval terminal (401) may display said actual operation values of the drive unit (13) received from the property memory (25) through the input device (405) and the connector (25a).

Degradation data is retrieved from the property memory (25) through the input device (405), the retrieval terminal (401) and the connector (25a) to apply or assign the data to a failure rate curve or approximation stored in the central memory (403). This configuration results in the failure condition of the drive unit (13) being clear on the failure rate curve characteristic or approximation such that the related failure rate rise (T) and optimum exchange time of the drive unit (13) are identifiable before malfunction.

As shown in FIG. 5, a plurality of gaming machines (200) are installed in entertainment halls or casinos and each document handler (1) of each gaming machine (200) includes a validator (2) with a mount chamber (21) where the drive unit (13) is attached. The property memory (25) in each drive unit (13) is connected to, or in communication with, the retrieval terminal (401) of the central controller (300) through the connector (25a). From a keyboard or image input device (405), instruction signals are forwarded to the retrieval terminal (401) of the central controller (300) through the connector (25a) to the property memory (25) to retrieve the necessary information within the property memory (25) that stores drive logs of physical values and authentication related to the drive unit (13).

As illustrated in FIGS. 1 to 3, document handler (1) comprises a mount chamber (21) formed in a housing (20) of the validator (2) for receiving the drive unit (13), and a pair of support holes (161) formed in inner walls of the mount chamber (21). The drive unit (13) shown in FIG. 2 is removably attached within the mount chamber (21) of the validator (2) shown in FIG. 5. Specifically, cylindrical hinges (160) of a frame (13b) in the drive unit (13) are detachably and rotatably attached in the support holes (161) of the housing (20) in the validator (2) to rotate the frame (13b) around the support holes (161) of the validator (2) and then to put the drive unit (13) within the mount chamber (21) of the validator (2).

Opening or closing a bottom lid (13a) of the drive unit (13) prevents power supply to the document handler (1) and removal of the drive unit (13) from the mount chamber (21) may be temporally inhibited. In this instance, once stopping power supply to the document handler (1) by opening and closing the bottom lid (13a) of the drive unit (13), power supply may be resumed, and the retrieval terminal (401) can detect connection in short time between the document handler (1) or the drive unit (13) and the connector (25a).

As illustrated in FIG. 5, if the retrieval terminal (401) is in communication with the property memory (25) of the drive unit (13) when removed from the mount chamber (21) of the validator (2), the retrieval terminal (401) can access or retrieve drive logs or warning signals saved in the property memory (25) to exhibit drive logs or warning signals on display (404) or operate alarms.

The central controller (300) comprises a central memory (403) for storing failure rate curve characteristics or failure rate approximations of the drive unit (13), a property comparator (402) connected to central memory (403) and the retrieval terminal (401). The property comparator (402) may compare physical values of the drive unit (13) received by the retrieval terminal (401) with failure rate curve characteristics of the drive unit (13) retained in the central memory (403) or may assign physical values of the drive unit (13) to failure rate approximations to compute the latest exchange time of the drive unit (13) and to exhibit the outputs on display (404).

The retrieval terminal (401) may read current deterioration level of the drive unit (13) based on the accumulated physical values and predicted failure rate rise (T) on failure rate curve characteristic in comparing accumulated physical values with failure rate curve characteristics or by assigning accumulated physical values to failure rate approximations to determine an exchange time of the drive unit (13) that reaches deterioration level of 80% before failure.

The sort sensor (11) of the validator (2) may read a coupon of regular size inserted into the validator (2), read image information printed on a bill or coupon put into the validator (2) and forward image information to the property memory (25) through the discriminator (12) also connected to the property memory (25) to authentication of documents by the discriminator (12). The central memory (403) also uses and saves regular size information of bills and coupons. Casino facilities may issue new coupons that maintain their regular size and configuration with no wrinkles to provide the discriminator (12) and the property memory (25) with accurate stored reference values for measuring transfer accuracy of the drive unit (13).

Specific coupons are utilized in limited areas with less degradation than that of currencies circulating through general markets, and so they have less change in dimension upon optically reading sizes of coupons. If there has been unusual transportation of the drive unit (13), the validation sensor (11) detects and forwards image information of the bills in irregular size to the discriminator (12) and the property memory (25). In this instance, the discriminator (12) drives the conveyor (5) in adverse and forward directions for repetitive validation. The property memory (25) may count the number of revalidations, and it produces warning signals if the revalidation number is over a predetermined frequency, for example, upon revalidation over five times, the property memory (25) determines deterioration in the transportation function of the conveyor (5).

When the validation sensor (11) detects a longer bill or coupon than a regular size, the property memory (25) may determine the occurrence of excessive abrasion, slipping or sliding and notify a manager of the same. For example, when rubber rollers of the conveyor (5) or the pusher (6) wear, rotation of rubber rollers increases causing the improper detection of a longer bill. In other words, if rubber rollers of the conveyor (5) or the pusher (6) produces slipping or sliding, the validation sensor (11) may falsely detect a longer bill. The sort sensor (11) may read a barcoded mark printed on coupons to confirm regular length and intervals between encoder pulses for measuring deterioration level in the drive unit (13).

The central controller (300) may automatically notify a manager of degradation and the necessity for replacing the drive unit (13), specifying a repair situation and/or showing repairing methods based on past maintenance and inspection history. The central controller (300) may judge warranty period based on signal/noise ratio data, suggestions of motor replacement based on motor operation numbers, degradation level based on physical values of the transfer motors (701) and the pusher motor (702), abrasion of gears, average ambient temperature, and content and number of recalled error codes.

To manufacture the document handler (1) according to the embodiments of the present invention, the drive unit (13) is provided with one or a plurality of drive sensors (24) for detecting physical values in the drive unit (13) and the property memory (25) for saving physical values detected by the drive sensors (24). Then, the drive unit (13) with the drive sensors (24) and the property memory (25) is detachably attached within the mount chamber (21) of validator (2).

The display method of the document handler (1) according to the embodiments of the present invention, comprises the steps of: providing one or a plurality of the drive sensors (24) for detecting physical values in the drive unit (13) and the property memory (25) for saving physical values detected by the drive sensors (24); detachably attaching the drive unit (13) within the validator (2) for discriminating authenticity of documents, the drive unit (13) having the drive sensors (24) and the property memory (25); transporting documents along the passageway (10) formed within the validator (2) by the drive unit (13); retrieving physical values saved in the property memory (25) by the retrieval terminal (401) to retrieve physical values; and depicting retrieved physical values on the display (404).

The display method of the document handler (1) according to the embodiments of the present invention, may further comprise assigning physical values located by the retrieval terminal (401) to the property comparator (402); comparing physical values received by the property comparator (402) with failure rate curve characteristics the of the drive unit (13) stored in the central memory (403) or assigning physical values received by the property comparator (402) to failure rate approximations of the drive unit (13) saved in the central memory (403); and computing by the property comparator (402) the latest exchange time shown by the physical values of the drive unit (13) to indicate the latest exchange time on display (404).

Above is described detecting failure by wear out through passage of total operation time of the drive unit (13), fatigue accumulation by repeated operation, overcurrent damage by repeated overload, thermal damage under high temperature environments, abnormal velocity or acceleration drop, cogging, slipping and sliding. Otherwise, the drive sensors (24) may detect other mechanical or electrical breakdown, malfunction and/or incomplete operation by the drive sensors (24) and store them in the property memory (25), and when failure time or frequency goes over a predetermined level, the property memory (25) may produce warning signals to urge the replacement of the drive unit (13).

Embodiments of the present invention may be altered without departing from the spirit and scope of the present invention. For example, when the conveyor (5) or the pusher (6) is driven with more than 10% rate in variability to a motor control value, the property comparator (402) may judge contamination or abrasion in belts or rollers and notify a manager. Otherwise, the driving load of the conveyor (5) or the pusher (6) may be digitized whereby an encoder may measure average velocity of motors driven with a constant torque or surveying time necessary for motors to reach target rates. Customer codes and shipping dates may be written down and stored in the property memory (25) of the drive unit (13) before shipping of the document handler (1) to check insurance periods of time for the document handler (1) or the drive unit (13), preventing sale of their used items.

While not shown in the drawings, the physical values and exchange of the drive unit (13) may be noticed from the central controller (300) to mobile terminals of managers in facilities of the document handler (1) to certify their quality maintenance. As the property memory (25) retains authentication information of the drive unit (13) or the document handler (1), a manager may investigate actual working environment of the drive unit (13) or the document handler (1) when the drive unit (13) shows unusual physical values.

The document handler (1) according to the embodiments of the present invention may be widely used in fields that utilize documents such as bills, for example, the fields of gaming machines, ATMs, ticket vending machines, clearing machines or vending machines. Moreover, the controller of gaming machine according to the embodiments of the present invention may be utilized in the various fields for controlling a plurality of gaming machines such as amusement or play facilities or casinos.

The present invention should not be limited in scope to the specific embodiments described herein. Various modifications, in addition to those explicitly mentioned, will be apparent to those skilled in the art based on the description and drawings provided. Such modifications are intended to fall within the scope of the invention.

We claim:

1. A document handler comprising:
a validator for determining authenticity of a document;
a passageway defined within the validator;
a drive unit for transporting the document along the passageway within the validator, wherein:
the drive unit is detachably attached to the validator, and
the drive unit comprises one or a plurality of drive sensors for detecting physical values within the drive unit, and a property memory for storing the physical values detected by the one or a plurality of drive sensors.

2. The document handler of claim 1, wherein the property memory stores:
drive logs that are converted by digitizing, grading and/or rating the physical values detected by the one or a plurality of drive sensors, and
wherein reductions in physical values detected by the one or a plurality of drive sensors indicate the deterioration level on the drive unit.

3. The document handler of claim 1, wherein the property memory stores authentication information for identifying the document handler or the drive unit to which the property memory is attached.

4. The document handler of claim 1, wherein the property memory stores a past maintenance inspection history of the drive unit.

5. The document handler of claim 1, wherein the one or a plurality of drive sensors include a clock encoder for measuring operation number and time of the drive unit; and
the property memory stores the operation number and time of the drive unit measured by the clock encoder and drive logs from the one or a plurality of drive sensors.

6. The document handler of claim 5, wherein the drive unit comprises a conveyor for transporting the document inserted into the validator along the passageway and a clock encoder for measuring operation number and time of the conveyor; and wherein:
the conveyor comprises a plurality of conveyor sensors for detecting physical values within the conveyor;
the drive logs include transfer logs that are converted by digitizing, grading and/or rating the physical values detected by the conveyor sensors; and
the property memory stores the operation number and time of the conveyor measured by the clock encoder and the transfer logs detected by the conveyor sensors.

7. The document handler of claim 5, wherein the document handler comprises a stacker for stowing the document sent along the passageway; and wherein:
the drive unit comprises a pusher for stowing the document into a container of the stacker;
the pusher comprises a plurality of stack sensors for detecting physical values within the pusher;
the drive logs include stack logs that are converted by digitizing, grading and/or rating the physical values detected by the stack sensors;
the clock encoder measures operation number and time of the pusher; and
the property memory stores the operation number and time of the pusher measured by the clock encoder and stack logs detected by the stack sensors.

8. The document handler of claim 6, wherein the conveyor of the drive unit comprises a drive belt for transporting the document, a transfer motor for operating the drive belt and a power transmission for transmitting drive power of the transfer motor to the drive belt; and
wherein the drive unit is a single assembly that integrally contains the drive belt, the transfer motor and the power transmission for arrangement of the drive unit within a mount chamber of a housing in the validator.

9. The document handler of claim 1, wherein the validator comprises a housing, a mount chamber formed in the housing to arrange the drive unit in the mount chamber, and a pair of support holes formed in the housing; and wherein:
the drive unit has a frame formed with cylindrical hinges that are detachably and rotatably attached in the support holes of the housing in the validator to allow rotation of the frame around the support holes of the validator;
the property memory of the drive unit is connected to a retrieval terminal through a connector when the drive unit is removed from the mount chamber of the validator; and
the retrieval terminal is connected to an input device to forward instruction signals from the input device to the property memory and to retrieve the drive logs from the property memory to send to the retrieval terminal.

10. A system of document handlers comprising:
a plurality of document handlers each comprising:
a validator for determining authenticity of a document, a passageway formed within the validator and a drive unit detachably attached within the validator for transporting the document along the passageway within the validator; and wherein:
the plurality of document handlers are individually connected to a central controller;
each of the drive units of each of the plurality of documents handlers includes one or more drive sensors for detecting physical values within the associated drive unit, and a property memory for storing authentication information that identifies the associated drive unit or document handler; and
each of the drive units configured to forward the physical values and authentication information to the central controller via a connector.

11. The system of claim 10 wherein the central controller comprises:
a retrieval terminal for receiving the physical values and authentication information forwarded from the property memory;
a central memory for storing failure rate curve characteristics and/or failure rate approximations of the drive unit; and
a property comparator for comparing the physical values of the drive unit received by the retrieval terminal or assigning the physical values of the drive unit to the failure rate curve characteristics or failure rate approximations to compute a latest exchange time of the drive unit in view of the failure rate rise on the failure rate curve characteristics or failure rate approximations.

12. The system of document handlers of claim 10, wherein the property memory stores the physical values of the drive unit detected by the one or more drive sensors, the physical values being digitized, graded and/or rated from the physical values for drive logs; and wherein:
a connector is configured to forward to the retrieval terminal the drive logs stored in the property memory and the authentication information of the drive unit or document handler;
the retrieval terminal is configured to receive the drive logs and authentication information via the connector; and
the property comparator compares the drive logs received by the retrieval terminal with the failure rate curve characteristics of the drive unit stored in the central memory or assigns the physical values of the drive unit to the failure rate approximations to compute the latest exchange time of the drive unit.

13. The system of document handlers of claim 10, wherein the drive unit comprises a clock encoder for measuring operation time of the drive unit; and
the property memory stores the operation time of the drive unit measured by the clock encoder and the drive logs sent from the one or more drive sensors.

14. The system of document handlers of claim 10, wherein the central controller comprises a display for indicating the drive logs received by the retrieval terminal, authentic information and the latest exchange time of the drive unit.

15. The system of document handlers of claim 13, wherein the drive unit includes a conveyor for transporting documents inserted into the validator along the passageway, and a transfer sensor for detecting the physical values within the conveyor; and wherein:
the drive logs include transfer logs that are digitized, graded and/or rated from the physical values detected by the transfer sensors; and
the property memory stores the operation number and time of the conveyor measured by the clock encoder and the transfer logs detected by the transfer sensors.

16. The system of document handlers of claim 13, wherein the drive unit comprises a pusher for stowing documents sent along the passageway into a container of the stacker and stack sensors for detecting physical values within the pusher; and wherein:
the drive logs include stack logs that are digitized, graded and/or rated from the physical values detected by the stack sensors;
the clock encoder measures operation time of the pusher, and
the property memory stores the operation time of the pusher measured by the clock encoder and the pusher logs sent from the stack sensors.

17. A controller of gaming machines comprising:
a plurality of gaming machines each provided with a document handler, and a central controller connected to each of the gaming machines or the document handlers within, wherein:
each of the document handlers comprises:
a validator for authenticating documents;
a passageway formed within the validator;
a drive unit for transporting the documents along with the passageway, said drive unit being detachably attached within the validator;
a validation sensor for optically reading image information of the document moving along the passageway and a discriminator for receiving the image information of the document from the validation sensor to decide authentication of the document;
wherein the drive unit includes drive sensors for detecting physical values within the drive unit, and a property memory for storing the physical values detected by the drive sensors and authentication information for identifying the drive unit or document handler; and
wherein the central controller comprises a retrieval terminal for retrieving and receiving the physical values and authentication information stored in the property memory of the drive unit, a central memory for storing failure rate curve characteristics or failure rate approximations of the drive unit, and a property comparator for comparing physical values of drive unit received by the retrieval terminal with failure rate curve characteristics of the drive unit retained in central memory or assigning the physical values of drive unit to the failure rate approximations to compute a latest exchange time of the drive unit.

18. The controller of gaming machines of claim 17, wherein the one or more drive sensors detect physical values within the drive unit, digitize, grade and/or rate the physical values into drive logs that are forwarded to the property memory to store the drive logs, or the drive sensors detect the physical values within the drive unit to forward the physical values to the property memory that digitizes, grades and/or rates the physical values into drive logs that are stored in the property memory; and wherein:
the retrieval terminal receives the drive logs stored in the property memory and authentication information of the drive unit or document handler; and
the property comparator compares the physical values of the drive unit received by the retrieval terminal with failure rate curve characteristics of the drive unit retained in the central memory or assigns the physical values of the drive unit to the failure rate approximations to compute a latest exchange time of the drive unit.

19. The controller of gaming machines of claim 18, wherein the one or more drive sensors comprise a clock encoder for measuring operation time of the drive unit; and
the property memory stores operation time of the drive unit measured by the clock encoder and drive logs from the one or more drive sensors.

20. The controller of gaming machines of claim 18, wherein the central controller comprises a display for indicating the drive logs received by the retrieval terminal, authentication information and the latest exchange time of the drive unit.

21. The controller of gaming machines of claim 18, wherein the central controller stores the authentication information of the drive unit mounted in the gaming machine in association with the authentication information of the gaming machine.

22. The controller of gaming machines of claim 17, wherein the discriminator images information of the inserted document to decide authenticity of the document; and wherein:
the discriminator is configured to produce an error signal to drive the drive unit for repetitive validation of the document responsive to the validation sensor detects a document with dimensions outside range of standard size; and
the property memory stores the number of times of repetitive validation for the drive logs.

23. A method for indicating a deterioration level of a document handler, comprising the steps of:
providing in a drive unit one or a plurality of drive sensors for detecting physical values in the drive unit and a property memory for saving physical values detected by the one or a plurality of drive sensors;
detachably attaching the drive unit within a validator for discriminating authenticity of documents;
causing a document to be transported along a passageway formed within validator by the drive unit;
retrieving the physical values saved in the property memory by a retrieval terminal; and
exhibiting the retrieved physical values on a display.

24. The method for indicating a deterioration level of a document handler of claim 23, further comprising:
inputting the physical values retrieved by the retrieval terminal into a property comparator;
comparing by the property comparator the received physical values with failure rate curve characteristics of the drive unit retained in a central memory or assigning the physical values of the drive unit to failure rate approximations; and
computing a closest exchange time or term for the drive unit and exhibiting the exchange time or term on a display.
